(19) United States
(12) Patent Application Publication
(10) Pub. No.: US 2005/0269865 A1
(43) Pub. Date: Dec. 8, 2005

(54) Wheel and a wheel disc

(76) Inventors: Jason Christopher Wonsowski, Warren, MI (US); Marcelino Marcao, Limeira (BR); Decio Antonio Escher Filho, Rio Claro (BR)

Correspondence Address: CARLSON, GASKEY & OLDS, P.C., 400 WEST MAPLE ROAD, SUITE 350, BIRMINGHAM, MI, 48009, US

(21) Appl. No.: 10/504,371

(22) PCT Filed: Jan. 17, 2003
(86) PCT No.: PCT/BR03/00005

§ 371 Date: Jul. 19, 2005

(30) Foreign Application Priority Data
Feb. 14, 2002 (BR) PI 0200351-1

(51) Int. Cl. B60B 3/10

(52) U.S. Cl. 301/63.105

(57) ABSTRACT

A vehicle wheel includes a substantially circular disc defining opposing first and second surfaces. The disc includes a first region, such as a flange, that is substantially perpendicular to the plane defined by the disc and projects from the first surface, and a second region adjacent to the first region. The second region has a continuous curvature extending toward the center of the disc. The continuous curvature defines a radius of curvature and a center of curvature, both of which being located on a side of the second surface.

### REFERENCE TO RELATED APPLICATIONS

The present invention claims the benefit of PCT International Application No. PCT/BR03/00005, filed on Jan. 17, 2003, which claims the benefit of Brazilian Patent Application No. PI0200351-1, filed on Feb. 14, 2002.

### TECHNICAL FIELD

The present invention relates to a vehicle wheel that is manufactured from a stamped material and is aesthetically similar to the wheels made from light-metal alloys by casting. Additionally, the present invention relates to a wheel disc for use on stamped wheels.

### BACKGROUND OF THE INVENTION

Vehicle wheels, especially those used in automobiles, are often made of stamped steel or other stamped material. Conventionally, stamped vehicle wheels comprise a cylindrical rim and a disc that are rigidly connected together by welding or fasteners (e.g., screws, rivets, etc.).

Stamped wheels may be subdivided into two types. One type of stamped wheel comprises a rim having a wall provided with two end regions, or flanges. The flanges configure a groove for fixing the tire and protrude from the wheel to form a region of the wheel where the wheel diameter is at its maximum. The flanges create a substantially curved J-shaped profile with its free tip substantially perpendicular to the rest of the flange body.

A second type of stamped wheel has a rim having only one separate flange, with the other flange being an integral part of a wheel disc. Like the first wheel type, the flanges of the disc and of the rim in the second wheel type form a region of the wheel where the wheel diameter is at its maximum. Wheels built according to the architecture of this second type are called integrated wheels.

In the first type of stamped wheel, the disc is fixed to the rim on the inner part of the rim. The inner part of the rim corresponds to the internal wall of a cylinder defined by the rim. Despite having reasonable functional performance and a reduced manufacturing cost, the first type of wheel has a drawback of being impossible to form into an attractive design due to the manufacturing geometry itself (which requires a disc having with a large curvature). This limits the first type of wheel to use in low-cost vehicles or in vehicles where the aesthetics of the wheel is considered unimportant.

The constructive architecture of the second type of stamped wheel, in turn, can be used in more attractive wheel designs while maintaining low manufacturing costs because the rim is fixed to the rear part of the disc (that is, the part usually facing the vehicle). Thus, the second type of stamped wheel allows formation of a disc without the exaggerated curvature required in the first type of wheel. Although the second type of wheel may have a more elaborate appearance, stamped wheels will still fail to have the beauty and elegance of wheels manufactured by casting with light-metal alloys, mainly because cast wheels have a larger curvature in the region of bores used to cool the brakes. Stamped wheels, by contrast, exhibit an abrupt break rather than a smooth, large curvature near the bores.

There is a desire for an integrated stamped wheel having an elaborate design similar to a wheel cast in light-metal alloys, but that maintains the ease and low cost of manufacture of stamped wheels.

### SUMMARY OF THE INVENTION

The invention is directed to a vehicle wheel comprising a substantially circular disc defining opposed first and second surfaces. The disc has a first circular region that is substantially perpendicular to the plane defined by the disc and projects from the first surface and a second region adjacent to the end region. The second region has a continuous curvature toward the center of the disc that defines a radius of curvature and a center of curvature toward the side of the second surface.

The invention also is directed to a vehicle wheel disc that is substantially circular and that defines opposed first and second main regions. The disc includes a first region that is substantially perpendicular to the plane defined by the disc and that projects from the first surface, and a second region adjacent to and originating from the first region. The second region has a convex curvature toward the center of the disc, defining a radius of curvature and a center of curvature towards the side of the second surface.

The present invention allows a stamped wheel to be as aesthetically attractive as wheels cast in light-metal alloys while still providing the advantages of reduced manufacturing costs. This combination allows the wheel to be used in a wider range of applications.

### BRIEF DESCRIPTION OF THE DRAWINGS

The present invention will now be described in greater detail with reference to an embodiment represented in the drawings.

FIG. 1 is a partial section view of a first embodiment of the wheel of the present invention, overlapped with respect to the equivalent view of an integrated view of the prior art; and

FIG. 2 is a partial section view a second configuration of the wheel of the present invention, overlapped with respect to the equivalent view of an integrated wheel of the prior art.

### DETAILED DESCRIPTION OF THE PREFERRED EMBODIMENTS

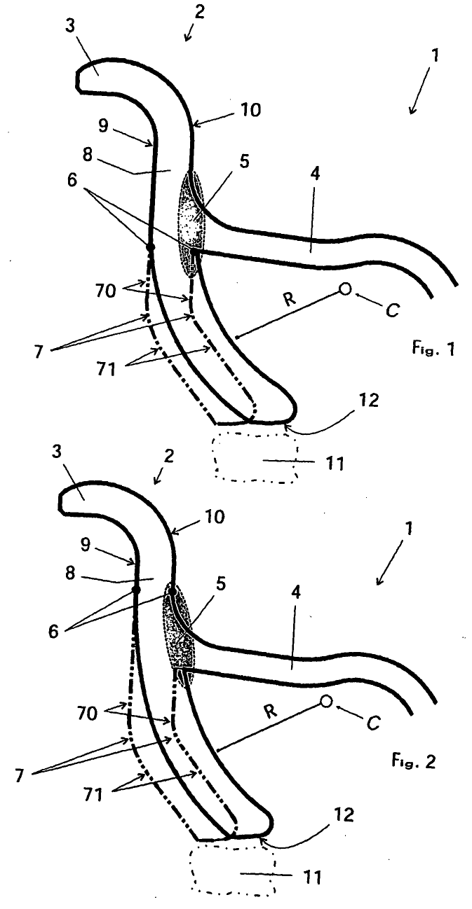

FIGS. 1 and 2 show a wheel 1 comprising a disc 2 and a rim 4 that are associated with each other. In the illustrated examples, the rim is cylindrical and has a side wall that comprises a first region (not shown) and a second region associated with the disc 2 in an attachment region 5. The attachment region 5 is preferably a welding region where the disc 2 and the rim 4 are welded together. However, the rim 4 and the disc 2 may be joined together in the attachment region 5 by other fastening means, such as screws, rivets, gluing, etc.

The first region of the rim 4 has a first protrusion, also called an end region or flange, that configures a groove for fixing the tire (not shown) to the wheel. The first protrusion forms an area of the rim 4 where the rim diameter is at its maximum. In one embodiment, the second region of the rim 4 is substantially parallel to the center line of the cylinder defined by the rim 4, but this characteristic does not limit the scope of the present invention.

The wheel disc 2 is substantially circular, and a protrusion (also referred to as a first region or flange 3) projects from the outer end region. The flange 3 configures a groove for fixing the tire (not shown) and forms a region of the disc 2 where the disc diameter is at its maximum. This flange 3 has a substantially curved J-shaped profile with its free tip substantially perpendicular to the rest of the flange body and preferably substantially perpendicular to the plane defined by the disc 2 as well. The disc 2 further comprises a first main surface 9 and a second main surface 10 that life opposite each other. The flange 3 projects from the first main surface 9. When the rim 4 and the disc 2 are associated, the first flange, the second flange 3 and the rim 4 together define a groove for correctly fixing the tire to the wheel 1.

A substantially annular second region 8 is adjacent to the flange 3. The flange 3 originates from the second region 8. At least one radius element projects toward the center of the disc 2 from an inner end edge 12 of the second region 8. The center of the disc 2 has a central element (not shown) having bores for fixing the wheel hub to the vehicle and an optional concentric bore for accommodating the tip of the vehicle axle (not shown).

Preferably, the wheel 1 contains a plurality of radius elements that are laterally interposed with bores or openings 11 for ventilation. FIGS. 1 and 2 show the region where the ventilation openings 11 are disposed. The ventilation openings 11 are also located from the inner end edge of the second region 8.

In order to facilitate the understanding of the invention, the inner end edge 12 of the second region 8, which is annular in this example, corresponds to the inner end of the second region 8 itself. From this point to the center of the ring formed by the second region 8, there is no more material and only an empty space.

The second region 8 of the wheel 1 of the present invention has a continuous curvature, preferably convex, toward the center of the disc 2. The second region 8 defines a radius of curvature R and a center of curvature C, each which are located on the side of a second main surface 10 of the disc 2. This means that from the flange 3 where the second region 8 originates, the second region 8 is curved without any interruptions of curvature toward the central region of the disc 2. The radius of curvature R points in the same direction as the curvature.

In a first embodiment of the wheel 1 of the present invention, the curvature begins at a point 6 (shown twice in FIG. 1 due to the fact that the curvature of the second region 8 occurs on both the first main surface 9 and the second main surface 10) that is located after the attachment region 5 of the disc 2 and the rim 4. This configuration causes the attachment region 5 to be flat and not curved.

In a second embodiment, illustrated in FIG. 2, the points 6 are located on the side of the flange 3 and preferably adjacent to it. This causes the entire second region 8 to have a convex curvature. Thus, in the second embodiment, the welding region 5 of the disc 2 and rim 4 is curved and located within the second region 8.

As noted above, the ventilation openings 11 start at the inner end edge 12 of the second region 8. Both the first and second main surfaces 9, 10 are parallel to each other and assume a convex curvature as far as the inner end edge where the ventilation opening 11 begins.

Prior art wheel structures have a different configuration for a region corresponding to the second region 8, as can be seen from the dashed lines in FIGS. 1 and 2. In these wheels, the second region 8 has, on both first and second main surfaces 9, 10, a first stretch 70 that is predominantly and substantially rectilinear and an abrupt curvature 7 occurring only at its inner end edge, from which a second substantially rectilinear stretch 71 projects. The first and second stretches 70, 71 may not be substantially rectilinear, but both of them always have a much smaller curvature than the abrupt curvature 7. In this way, the wheel of the prior art does not suggest forming a continuous curvature of the second region 8 toward the center of the disc 1.

A support ring or a profiled ring (not shown) may used in manufacturing the disc 2. The support ring or profiled ring ensures correct centering and geometry of the disc 2, preventing the disc 2 from shifting out of alignment and enabling correct fastening of the rim 4 and the disc 2 together in a centered and aligned way.

An example of a preferred embodiment having been described, one should understand that the scope of the present invention embraces other possible variations, being limited only by the contents of the accompanying claims, which include the possible equivalents.

1-11. (canceled)

12. A vehicle wheel, comprising:
a substantially circular disc defining opposed first and second main surfaces, the disc having a first region that is substantially perpendicular to a plane defined by the disc and that projects from the first surface and a second region adjacent to the first region,
wherein the second region has a continuous curvature toward a center of the disc, the continuous curvature defining a radius of curvature and a center curvature that are both located on a side of the second main surface.

13. The wheel of claim 1, further comprising a substantially circular rim coupled with the second region at an attachment region.

14. The wheel of claim 2, wherein the continuous curvature of the second region begins at a point after the attachment region between the disc and the rim.

15. The wheel of claim 2, wherein the continuous curvature of the second region begins at a point located before the attachment region between the disc and the rim, the point being located in the first region.

16. The wheel of claim 2, wherein the disc and the rim are welded together in the attachment region.

17. The wheel of claim 2, further comprising at least one fastener connecting the rim and the disc in the attachment region.

18. The wheel of claim 1, further comprising at least one radius element that projects from the second region toward the center of the disc.

19. A substantially circular disc for use on a vehicle wheel, comprising:
a first main surface and a second main surface, wherein the first and second main surfaces are opposite each other;
a first region that is substantially perpendicular to a plane defined by the disc, wherein the first region projects from the first surface; and
a second region adjacent to the first region and originating from the first region, wherein the second region has a continuous convex curvature toward a center of the disc, the convex curvature defining a radius of curvature and a center of curvature on a side of the second main surface.

20. The disc of claim 8, wherein an inner surface of the second region is adapted to couple with a rim in at least one attachment region between the disc and the rim.

21. The disc of claim 8, wherein the continuous convex curvature begins at a point located after the inner surface of the second region where the disc is attachable to the rim, the point being located toward the center of the disc.

22. The disc of claim 8, wherein the continuous convex curvature begins at a point located before the inner surface of the second region where the disc is attachable to the rim, the point being located toward the first region.

23. The disc of claim 8, further comprising at least one radius element that projects from the second region toward the center of the disc.
